(19) United States
(12) Patent Application Publication
(10) Pub. No.: US 2009/0323493 A1
(43) Pub. Date: Dec. 31, 2009

(54) MULTILAYER OPTICAL RECORDING MEDIUM, RECORDING DEVICE, AND RECORDING LASER POWER ADJUSTMENT METHOD

(75) Inventors: Takahiro OHKUBO, Kanagawa (JP); Shoei Kobayashi, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/490,664

(22) Filed: Jun. 24, 2009

(30) Foreign Application Priority Data
Jun. 27, 2008 (JP) 2008-168669

(51) Int. Cl. G11B 7/20; G11B 7/26; G11B 7/00

(52) U.S. Cl. 369/94; 369/283; 369/116; G9B/7; G9B/7.137; G9B/7.195

(57) ABSTRACT

A multilayer optical recording medium includes three or more recording layers formed in a thickness direction. Trial writing areas provided in the respective recording layers to adjust the power of recording laser are formed not to overlap at a position in a planar direction in adjacent ones of the recording layers. Further, the trial writing areas are formed to have an overlapping portion at a position in the planar direction in one of the recording layers and at least another one of the recording layers not adjacent to the one of the recording layers.

### BACKGROUND OF THE INVENTION

1. Field of the Invention

The present invention relates to a multilayer optical recording medium, such as a multilayer optical disc, which includes three or more recording layers, particularly to the setting of trial writing areas in the recording layers. The present invention further relates to a recording device and a recording laser power adjustment method for the multilayer optical recording medium as described above.

2. Description of the Related Art

The related art includes International Patent Application Publication No. 05/034110 and Japanese Unexamined Patent Application Publication No. 2004-295940.

An optical recording medium, such as a Blu-ray Disc (registered trademark), for example, is in common use. Information is recorded on or reproduced from the optical recording medium with the use of semiconductor laser.

The recording on an optical disc with the use of semiconductor laser is significantly affected by a change in the laser power due to a change in temperature or a change over time, a variety of skews and offsets due to an adjustment error in the manufacturing process, and a shift in the recording condition in the drive control. Therefore, particularly in a recording-type optical disc, such as a write-once disc and a rewritable disc, the variation in the laser drive circuit and the optical device is suppressed to perform accurate light emission waveform control.

In an actual information recording device, it is common to perform, immediately before actual recording of user data, the search for the optimal laser power with the use of a trial writing area provided in each recording layer and the adjustment of the recording laser power and the strategy, to thereby optimize the recording condition.

In this trial writing process for the adjustment of the recording laser power, the removal of the above-described perturbation and so forth, the optimization of the recording power, and the optimization of the laser drive pulse are performed in a state in which the optimal recording condition is unknown. In the search for the optimal condition, the application of laser light having an unnecessarily high energy or the laser application with the laser drive pulse having an inappropriate width (laser light emission time period) occur in some cases. Such laser application may cause serious damage to the trial writing area in the recording layer.

Further, it is generally considered that, in a so-called multilayer optical disc including a plurality of recording layers formed on a disc substrate, such factors as stray light and a recorded signal leaking from a recording layer different from the focused recording layer affect the servo operation and the quality of a reproduced signal. Accordingly, desired trial writing control may be prevented, depending on the recorded state of the different recording layer. As a result, there arises an issue of difficulty in deriving the accurate optimization condition.

That is, when the trial writing is performed in the trial writing area of a certain recording layer to perform the laser power adjustment, the trial writing is affected by the trial writing area of another recording layer provided at the same position in the planar direction (the radial direction of the disc) as the trial writing area of the certain recording layer (i.e., the position at which the two trial writing areas overlap as viewed in the thickness direction). This is because the trial writing area of the another recording layer may have been damaged as described above, or a used region and an unused region may coexist in the trial writing area, and thus the recorded state is uncertain.

To address the above-described issue, there have been proposed in the past a method in which the trial writing areas of different recording layers are shifted from each other in the radial direction of the recording layers, as disclosed in the first patent application publication listed above, for example, and a method in which the same radial position is not used for the trial writing in the trial writing areas of different recording layers. An existing two-layer standard of the Blu-ray Disc also specifies that the trial writing areas provided in the respective recording layers in a read-in zone on the inner circumferential side of the disc are shifted from each other in the radial direction of the recording layers.

### SUMMARY OF THE INVENTION

Meanwhile, an increase in the recording capacity of an information recording medium has been constantly sought after. For instance, in the example of the Blu-ray Disc, further multilayering of the recording layers for providing a three-layer structure, a four-layer structure, and so forth to achieve a dramatic increase in the capacity is expected.

Herein, there arises an issue of the arrangement of the trial writing areas described above. The trial writing areas are normally provided in a region on the inner circumferential side of a disc, for example, i.e., a radius range secured as a so-called read-in region or the like. Further, in an attempt to achieve further multilayering, it is physically difficult to shift the trial writing areas of the recording layers from one another, i.e., to set the trial writing areas of the recording layers at respective different radial positions such that the trial writing areas do not have an overlapping positional relationship as viewed in the thickness direction of the disc. This is because, while a certain range of sufficient area is desired to be secured as the trial writing area in consideration of the number of executions of the laser power adjustment and the demand for higher adjustment accuracy, the radius range secured as the read-in region or the like is limited.

In view of the above, it is desirable in the present invention to provide an area arrangement method capable of eliminating, in a multilayer optical recording medium including three or more recording layers, an adverse effect of interlayer interference caused by a recording condition optimization process performed in the trial writing area of a recording layer different from the focused recording layer, and also capable of securing a sufficient trial writing area in each of the recording layers.

A multilayer optical recording medium according to an embodiment of the present invention includes three or more recording layers formed in a thickness direction. Trial writing areas provided in the respective recording layers to adjust the power of recording laser are formed not to overlap at a position in a planar direction in adjacent ones of the recording layers. Further, the trial writing areas are formed to have an overlapping portion at a position in the planar direction in one of the recording layers and at least another one of the recording layers not adjacent to the one of the recording layers.

Further, in even-numbered ones or odd-numbered ones of the recording layers, the trial writing areas may be formed to have an overlapping portion at a position in the planar direction.

Alternatively, the trial writing areas may be formed to have an overlapping portion at a position in the planar direction in one of the recording layers and another one of the recording layers, between which at least two or more of the other recording layers are interposed.

A recording device according to an embodiment of the present invention is a recording device for the above-described multilayer optical recording medium. The recording device includes an optical head unit, a laser driving unit, and a control unit. The optical head unit is configured to apply the recording laser to the multilayer optical recording medium to write information thereon. The laser driving unit is configured to drive the optical head unit to output the recording laser. The control unit is configured to, in the execution of the laser power adjustment of the recording laser output from the optical head unit, identify the position in the planar direction of the trial writing areas in accordance with the recording layer set as an adjustment target, determine a trial writing execution range within the identified position in the planar direction, and control the laser driving unit and the optical head unit to execute trial writing in the trial writing execution range.

A recording laser power adjustment method according to an embodiment of the present invention is a recording laser power adjustment method of a recording device for the above-described multilayer optical recording medium. The recording laser power adjustment method includes the steps of: identifying the position in the planar direction of the trial writing areas in accordance with the recording layer set as an adjustment target; determining a trial writing execution range within the identified position in the planar direction; executing trial writing in the determined trial writing execution range; and reproducing data in a region subjected to the trial writing, determining an optimal laser power, and setting the determined optimal laser power as the recording laser power.

In the embodiments of the present invention as described above, the multilayer optical recording medium is structured such that the trial writing areas included in the respective recording layers are basically arranged not to overlap at the same position in the planar direction (radial position of the disc) in adjacent ones of the recording layers, and are formed to have an overlapping portion at a position in the planar direction in unadjacent ones of the recording layers. To have an overlapping portion refers to, for example, a state in which the trial writing areas are set in the same radial position range so as to have a positional relationship wherein the entire trial writing areas overlap with each other in the thickness direction (optical axis direction of the applied recording laser), or a state in which the trial writing areas have a positional relationship wherein a part of both or one of the trial writing areas overlap with the other trial writing area in the thickness direction.

According to the present invention, the multilayer optical recording medium is structured such that the trial writing areas are arranged not to overlap in the thickness direction in at least adjacent ones of the recording layers. Accordingly, it is possible to eliminate the influence of the trial writing performed in one of the recording layers on the trial writing performed in another one of the recording layers. In addition, in unadjacent ones of the recording layers, the trial writing areas are permitted to overlap in the thickness direction or encouraged to be set in an overlapping manner. Accordingly, even if the number of the recording layers is increased, the trial writing areas for all of the layers can be provided within a limited physical area, and thus the area can be effectively used. Further, even if the number of the recording layers is increased, an area having a sufficient size can be secured as the trial writing area. Accordingly, the laser power adjustment using the trial writing can be improved in reliability.

### BRIEF DESCRIPTION OF THE DRAWINGS

FIGS. 1A and 1B are explanatory diagrams of an area structure and a layer structure, respectively, of an optical disc according to an embodiment of the present invention;

FIG. 2 is an explanatory diagram of a first OPC area arrangement example according to an embodiment;

FIGS. 3A to 3E are explanatory diagrams of a four-layer disc to an eight-layer disc, in each of which the first OPC area arrangement example according to the embodiment is employed;

FIGS. 4A and 4B are explanatory diagrams of modified examples of the first OPC area arrangement example according to the embodiment;

FIG. 5 is an explanatory diagram of a second OPC area arrangement example according to an embodiment;

FIGS. 6A to 6E are explanatory diagrams of a four-layer disc to an eight-layer disc, in each of which the second OPC area arrangement example according to the embodiment is employed;

FIG. 7 is an explanatory diagram of a third OPC area arrangement example according to an embodiment;

FIGS. 8A to 8E are explanatory diagrams of a four-layer disc to an eight-layer disc, in each of which the third OPC area arrangement example according to the embodiment is employed;

FIG. 9 is a block diagram of a disc drive device according to an embodiment; and

FIG. 10 is a flowchart of laser power adjustment processing according to an embodiment.

### DESCRIPTION OF THE PREFERRED EMBODIMENTS

Embodiments of the present invention will be described below. In the embodiments, an optical disc conforming to the Blu-ray Disc format will be taken as an example of a multilayer optical recording medium. The description will be made in the following order: 1) Disc Structure and First OPC Area Arrangement Example, 2) Second OPC Area Arrangement Example, 3) Third OPC Area Arrangement Example, 4) Disc Drive Device, and 5) Laser Power Adjustment Processing.

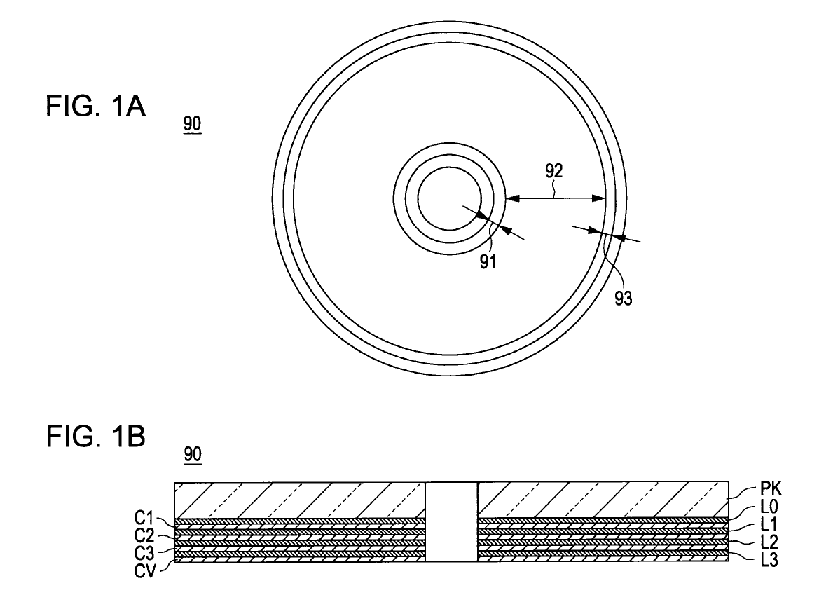

1) Disc Structure and First OPC Area Arrangement Example: FIG. 1A illustrates an optical disc 90 as viewed planarly, and an area structure thereof in the radial direction. The optical disc 90 is a disc-shaped recording medium having a diameter of 12 cm, for example, and the area structure thereof is roughly divided into an inner circumferential area 91, a data zone 92, and an outer circumferential area 93.

The data zone 92 constitutes a main recording area, in which so-called user data is recorded. The user data herein refers to main data to be stored with the use of the optical disc 90, such as video data, audio data, text data, computer-use data, a software program, and so forth.

The inner circumferential area 91 is used as a so-called management area. In the case of a single-layer disc including a single recording layer, the inner circumferential area 91 is an area used as a so-called read-in zone. In the case of a multilayer disc including a plurality of recording layers, the inner circumferential area 91 is used as a read-in zone, an inner zone, a read-out zone, and so forth in the respective layers. In the inner circumferential area 91, the physical information of the disc, the setting information of a recording or reproduction operation, the information for managing the area structure and replacement, a trial writing area, and so forth are formed.

In the case of a single-layer disc, the outer circumferential area 93 is an area used as a so-called read-out zone. In the case of a multilayer disc including a plurality of recording layers, the outer circumferential area 93 is used as a read-out zone or an outer zone in each of the layers.

In the present example, a recordable disc, such as a write-once disc and a rewritable disc, is assumed.

FIG. 1B schematically illustrates a layer structure of the optical disc 90, which is configured to be a four-layer disc. The optical disc 90 includes a disc substrate PK molded by injection molding or the like using polycarbonate or the like, for example. On a surface of the disc substrate PK, concavo-convex shapes are formed as a wobbling groove. On the surface, a reflecting film and a recording material layer are formed to form a first recording layer L0.

Further, on the recording layer L0, an intermediate layer C1 is formed. On a surface of the intermediate layer C1, concavo-convex shapes are formed as a wobbling groove. On the surface, a semitransparent reflecting film and a recording material layer are formed to form a second recording layer L1.

Further, on the recording layer L1, an intermediate layer C2 is formed. On a surface of the intermediate layer C2, concavo-convex shapes are formed as a wobbling groove. On the surface, a semitransparent reflecting film and a recording material layer are formed to form a third recording layer L2.

Further, on the recording layer L2, an intermediate layer C3 is formed. On a surface of the intermediate layer C3, concavo-convex shapes are formed as a wobbling groove. On the surface, a semitransparent reflecting film and a recording material layer are formed to form a fourth recording layer L3.

On the recording layer L3, a cover layer CV is formed. Each of the recording layers L0, L1, L2, and L3 includes a portion formed with embossed pit rows, such as a part of the inner circumferential area 91.

In fact, the thickness of the optical disc 90 is approximately 1.2 mm, and the thickness of the disc substrate PK is approximately 1.1 mm. Further, the respective layers from the recording layer L0 to the cover layer CV are formed in a thickness of approximately 100 μm. A reduction in the interlayer distance between the recording layers results in an increase in the influence of stray light and crosstalk. In some of multilayer media, therefore, the bottommost recording layer (L0) is formed at a position 100 μm plus a few μm away from the front surface of the cover layer CV. Although this FIG. 1B illustrates the example of a four-layer disc, a three-layer disc or a five or more-layer disc is also formed into a similar structure, with the intermediate layers and the cover layer thereof adjusted in thickness and so forth.

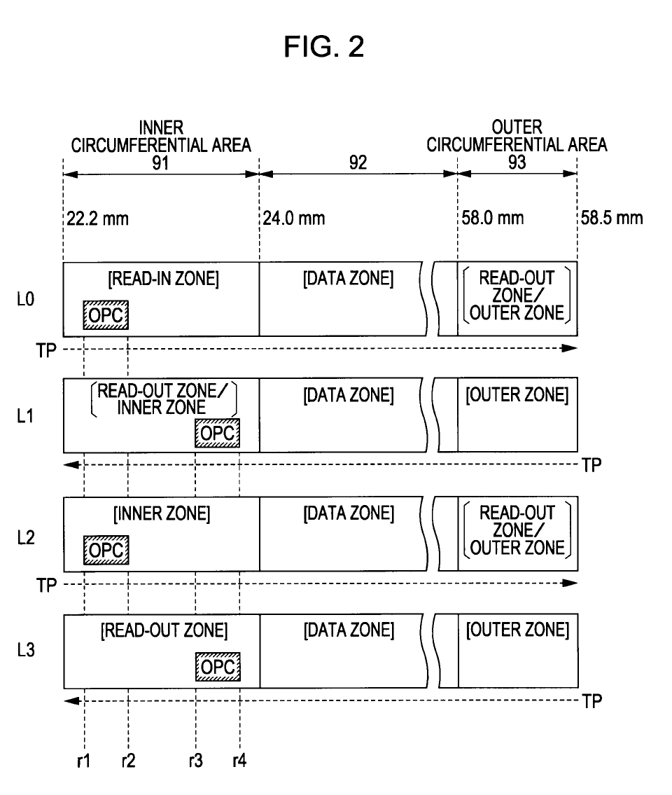

With reference to FIG. 2, description will be made of an arrangement example of the trial writing areas (OPC (Optimum Power Control) areas), which is a characteristic structure of the optical disc 90 of the present example. FIG. 2 illustrates an area structure in which the recording layers L0, L1, L2, and L3 are viewed in the radial direction.

Firstly, the inner circumferential area 91 is an area from a radial position of 22.2 mm to a position immediately before a radial position of 24.0 mm. The data zone 92 starts at the radial position of 24.0 mm. Further, the outer circumferential area 93 ranges from a radial position of 58.0 mm to a radial position of 58.5 mm. These radial positions of the respective areas are examples. Thus, these radial positions may be set differently.

In the following description, an opposite track path will be assumed. The opposite track path refers to a track path format in which the scanning direction of a recording or reproduction scanning is from the inner circumference to the outer circumference in the first recording layer, from the outer circumference to the inner circumference in the second recording layer, and from the inner circumference to the outer circumference in the third recording layer, for example, i.e., the scanning direction alternately reverses. As indicated by a dashed-line arrow as a track path TP in FIG. 2, the scanning direction is from the inner circumference to the outer circumference in the recording layers L0 and L2, and from the outer circumference to the inner circumference in the recording layers L1 and L3.

A format in which the scanning is performed from the inner circumference to the outer circumference in all of the recording layers is referred to as a parallel track path. The present invention is also applicable to the parallel track path.

In the recording layer L0 of FIG. 2, the inner circumferential area 91 is a read-in zone. The outer circumferential area 93 is a read-out zone, if the recording is completed in one layer. Meanwhile, if the recording layer L1 and the subsequent layer(s) are used for the recording, the outer circumferential area 93 is regarded as an outer zone, which is a transition area to the recording layer L1.

In the recording layer L1, the scanning proceeds toward the inner circumference from the outer circumferential area 93 regarded as the outer zone. The inner circumferential area 91 is a read-out zone, if the recording is completed in two layers. Meanwhile, if the recording layer L2 and the subsequent layer are used for the recording, the inner circumferential area 91 is regarded as an inner zone, which is a transition area to the recording layer L2.

In the recording layer L2, the scanning proceeds toward the outer circumference from the inner circumferential area 91 regarded as the inner zone. The outer circumferential area 93 is a read-out zone, if the recording is completed in three layers. Meanwhile, if the recording layer L3 is used for the recording, the outer circumferential area 93 is regarded as an outer zone, which is a transition area to the recording layer L3.

In the recording layer L3, the scanning proceeds toward the inner circumference from the outer circumferential area 93 regarded as the outer zone. The inner circumferential area 91 is a read-out zone.

In each of the recording layers L0 to L3, the trial writing area (OPC area) is provided for the laser power adjustment for the recording on the recording layer. In the trial writing, the outer circumferential area 93 may be used in some cases. However, it is normally considered appropriate to perform the trial writing in the inner circumferential area 91 to perform precise laser power adjustment by minimizing the influence of warpage of the disc. Therefore, the trial writing area (OPC area) is set within the inner circumferential area 91.

In the example of FIG. 2, the OPC area is set to be the range from a radius of r1 to a radius of r2 in the even-numbered recording layers L0 and L2. Meanwhile, in the odd-numbered recording layers L1 and L3, the OPC area is set to be the range from a radius of r3 to a radius of r4. In the inner circumferential area 91, the area excluding the OPC area is used as a recording area for recording the variety of management information described above.

That is, in the present example, the OPC areas provided in the recording layers L0 to L3 to be used for the trial writing for the recording laser power adjustment are formed not to overlap at a position in the planar direction (i.e., radial position) in adjacent ones of the recording layers. Further, in one of the recording layers and at least another one of the recording layers not adjacent to the one of the recording layers, the OPC areas overlap at a position in the planar direction.

That is, in the four-layer disc of this example, the OPC areas are formed to overlap at the same radial position in even-numbered ones of the recording layers, and to overlap at the same radial position in odd-numbered ones of the recording layers. Further, in adjacent ones of the recording layers, the OPC areas are provided at different radial positions, i.e., the OPC areas are arranged not to overlap as viewed in the thickness direction of the disc.

With this structure, the influence of the trial writing performed in a certain recording layer on the trial writing performed in a recording layer adjacent to the certain recording layer can be eliminated. In addition, the trial writing areas are arranged to overlap in the thickness direction in unadjacent recording layers. Therefore, the OPC area having a sufficient area size can be appropriately secured in each of the recording layers within the limited range of the inner circumferential area 91.

It has been confirmed by an experiment that a change in the state of an OPC area due to the trial writing performed in the corresponding recording layer hardly affects another recording layer, unless the recording layer is adjacent to the another recording layer. In terms of the accuracy of the trial writing, therefore, practically there is no problem in providing the OPC areas at the same radial position in layers between which at least one layer is interposed.

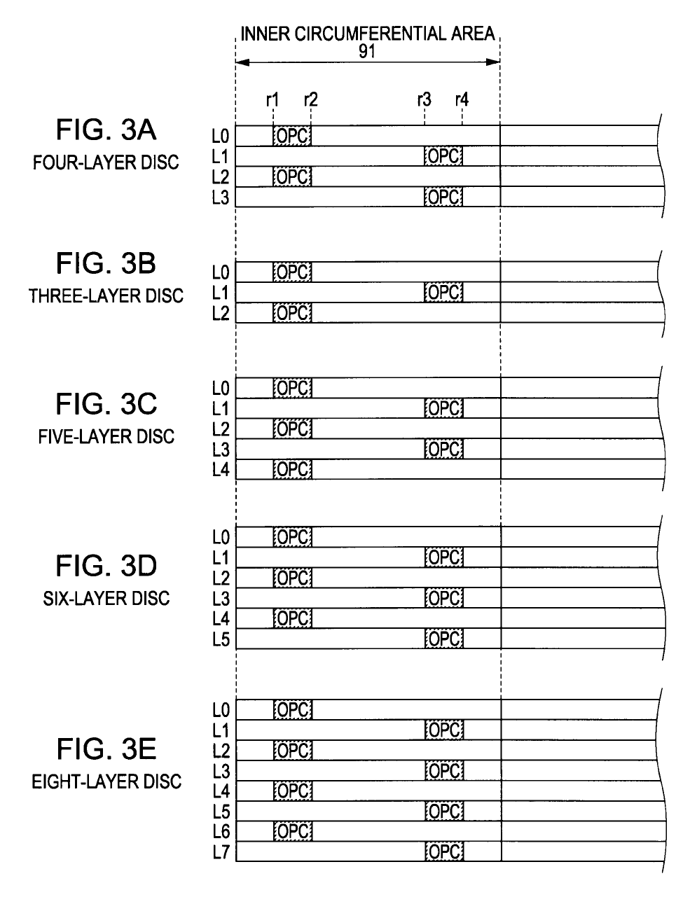

FIGS. 3A to 3E illustrate examples having different numbers of recording layers. FIG. 3A illustrates the arrangement of the OPC areas in the four-layer disc illustrated in FIG. 2. Similarly to this example, FIGS. 3B to 3E illustrate examples of a three-layer disc, a five-layer disc, a six-layer disc, and an eight-layer disc, respectively.

In all of the examples, the OPC areas in even-numbered recording layers are formed at the same radial position, and the OPC areas in odd-numbered recording layers are formed at the same radial position. The OPC areas in adjacent recording layers, however, are arranged not to overlap in the disc thickness direction. Particularly, in a disc having an increased number of recording layers, as in the five-layer disc to the eight-layer disc, it is physically difficult to arrange the OPC areas in all of the recording layers by simply shifting the OPC areas from one another in the radial direction, or the size of the OPC area in each of the recording layers should be reduced. According to the structure of the present example illustrated in FIGS. 3A to 3E, however, such issue does not arise.

Meanwhile, in the examples of FIG. 2 and FIGS. 3A to 3E, the size and the radial position of the OPC areas are completely matched and overlapped in the even-numbered recording layers and in the odd-numbered recording layers, for example, such that the OPC areas completely overlap in the thickness direction. Alternatively, the OPC areas may be partially overlapped in the radial direction.

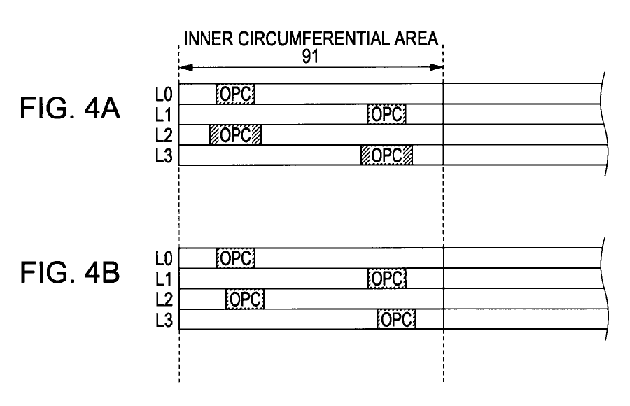

For instance, an example in which the OPC areas of the respective recording layers have different sizes is also conceivable. FIG. 4A illustrates an example of a four-layer disc, in which the size of the OPC area is set to be larger in the recording layers L2 and L3 than in the recording layers L0 and L1. The OPC area of the recording layer L2 has a positional relationship in which a part of the OPC area overlaps with the OPC area of the recording layer L0 in the thickness direction. Further, the OPC area of the recording layer L3 has a positional relationship in which a part of the OPC area overlaps with the OPC area of the recording layer L1 in the thickness direction.

Further, FIG. 4B illustrates an example of a four-layer disc, in which the OPC areas in the recording layers L0 to L3 are set to have the equal size but are arranged partially shifted from each other. That is, the OPC areas in the recording layers L0 and L2 have a positional relationship in which the OPC areas partially overlap in the thickness direction. Further, the OPC areas in the recording layers L1 and L3 also have a positional relationship in which the OPC areas partially overlap in the thickness direction.

As in the examples of FIGS. 4A and 4B, for example, the OPC areas may be arranged in a relationship in which the OPC areas in the even-numbered recording layers and the OPC areas in the odd-numbered recording layers partially overlap in the thickness direction.

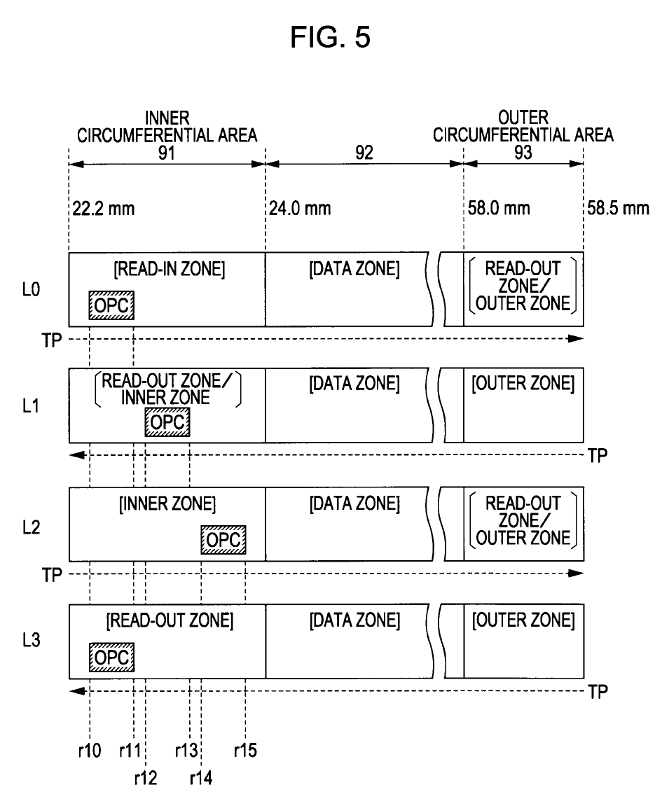

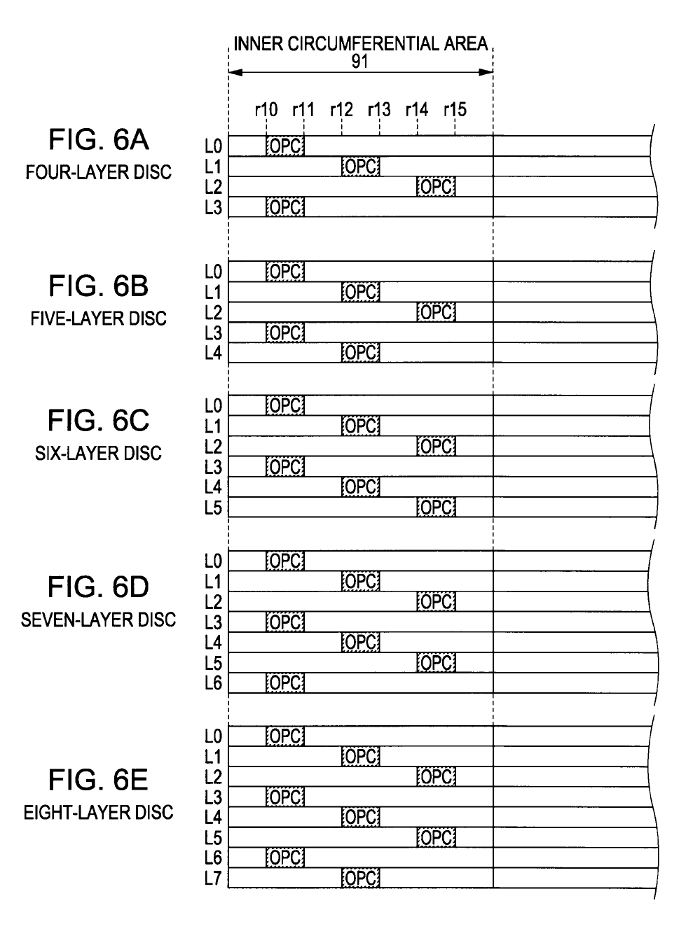

2) Second OPC Area Arrangement Example: Subsequently, a second arrangement example of the OPC areas will be described with reference to FIG. 5 and FIGS. 6A to 6E. In the second arrangement example of the OPC areas, the recording layers including the trial writing areas (OPC areas) formed to have an overlapping portion at a position in the planar direction are two recording layers between which two other recording layers are interposed.

As illustrated in FIG. 5, in the recording layers L0 and L3, the OPC area is set to be the range from a radius of r10 to a radius of r11. In the recording layer L1, the OPC area is set to be the range from a radius of r12 to a radius of r13. In the recording layer L2, the OPC area is set to be the range from a radius of r14 to a radius of r15. That is, the recording layers L0 and L3, in which the OPC areas are located at the same position in the radial direction (overlapped in the thickness direction), are apart from each other with two other layers (L1 and L2) interposed therebetween.

FIGS. 6A to 6E illustrate examples of a four-layer disc to an eight-layer disc, in each of which the OPC areas are thus provided at the same radial position in recording layers apart from each other with two other layers interposed therebetween. In all of the examples, the recording layers in which the OPC areas are provided at the same radial position are apart from each other with two other recording layers interposed therebetween. As in these examples, the OPC areas having the overlapping positional relationship in the thickness direction are further separated from each other in the thickness direction. Thereby, the influence of one of the OPC areas on the other OPC area can be further reduced. Also in this case, the example in which the OPC areas have a partially overlapping positional relationship, as described in FIGS. 4A and 4B, is conceivable.

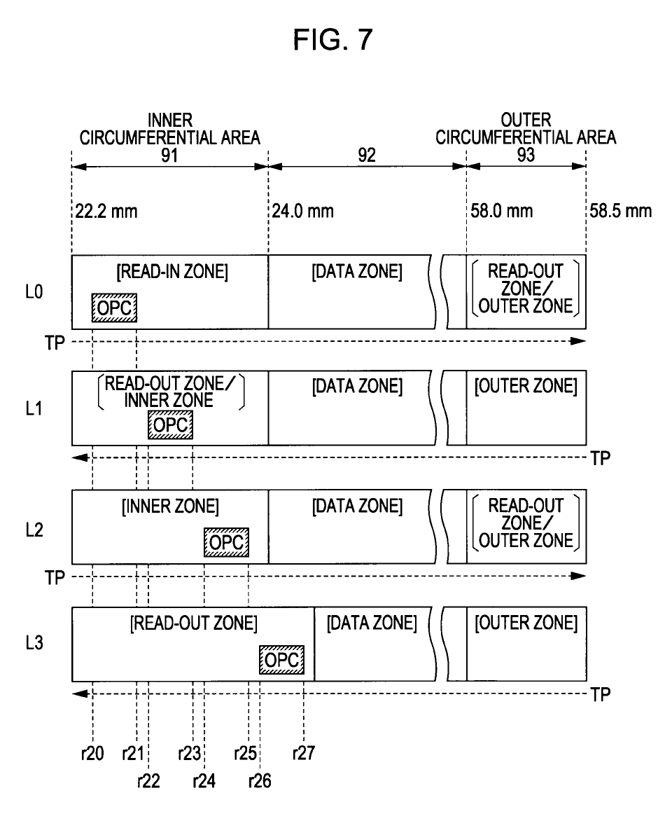

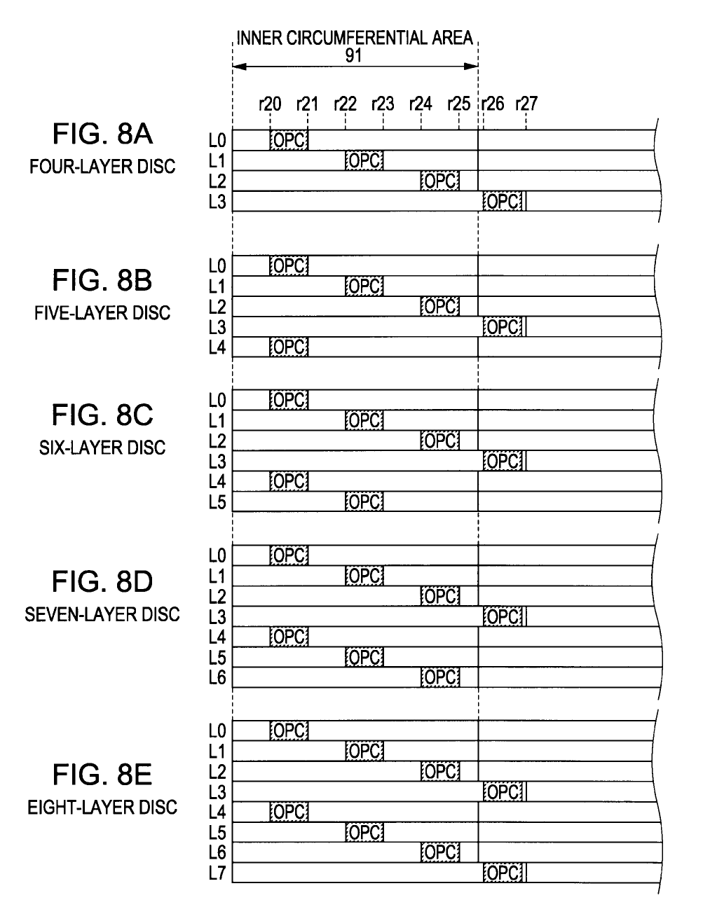

3) Third OPC Area Arrangement Example: Subsequently, a third arrangement example of the OPC areas will be described with reference to FIG. 7 and FIGS. 8A to 8E. In the third arrangement example of the OPC areas, the inner circumferential area 91 is expanded toward the data zone 92 in one or more of the recording layers to secure the trial writing area (OPC area).

As illustrated in FIG. 7, the OPC area is set to be the range from a radius of r20 to a radius of r21 in the recording layer L0, the range from a radius of r22 to a radius of r23 in the recording layer L1, and the range from a radius of r24 to a radius of r25 in the recording layer L2. Further, the OPC area is set to be the range from a radius of r26 to a radius of r27 in the recording layer L3. In this case, all or a part of the range from the radius of r26 to the radius of r27 corresponds to the original radial position of the data zone 92.

That is, the inner circumferential area 91 is expanded in the recording layer L3 to prevent the overlapping of the OPC areas in adjacent recording layers. As a result of this, the example of the four-layer disc in FIG. 7 does not include recording layers in which the OPC areas are located at the same radial position. In the case of a five or more-layer disc, however, there are recording layers in which the OPC areas are located at the same radial position, as illustrated in FIGS. 8B to 8E.

FIGS. 8A to 8E illustrate examples of a four-layer disc to an eight-layer disc, in each of which the inner circumferential area 91 is expanded in one or more of the recording layers to provide the OPC area. In the five-layer disc of FIG. 8B to the eight-layer disc of FIG. 8E, the OPC areas are located at the same radial position in recording layers between which three other recording layers are interposed. This example is suitable when it is desired to separate, as far as possible, the recording layers in which the OPC areas are located at the same radial position, for example.

Further, the example of expanding the inner circumferential area 91 as described above can be employed in a variety of cases in which the range of the inner circumferential area 91 is insufficient due to the size of a variety of management regions desired to be secured in the inner circumferential area 91, the desired size the OPC area, and so forth. FIGS. 7 and 8A illustrate the example of the four-layer disc, in which all of the OPC areas are located at different radial positions. However, it is also conceivable, in a four-layer disc or a three-layer disc, that the inner circumferential area 91 is expanded in one or more recording layers to provide the OPC area, and that there are recording layers in which the OPC areas are located at the same radial position, for example. For instance, in the examples of FIGS. 3A and 3B, the OPC areas in the range from the radius of r3 to the radius of r4 may be set at the original radial position of the data zone 92.

Also in the third arrangement example of the OPC areas, the example in which the OPC areas have a partially overlapping positional relationship in the radial position range, as described in FIGS. 4A and 4B, is conceivable.

4) Disc Drive Device: Subsequently, description will be made of a disc drive device which performs recording and reproduction operations on the optical disc 90 of the present embodiment. The disc drive device of the present embodiment is assumed to be able to perform the reproduction operation and the recording operation on a reproduction-only disc and a recordable disc (a write-once disc or a rewritable disc), respectively, which conform to the Blu-ray Disc standard. As described earlier, the optical disc 90 of the embodiment described above is a recordable disc.

In the case of a recordable disc, phase-change marks or dye-change marks are recorded thereon or reproduced therefrom under the condition in which laser having a wavelength of 405 nm (so-called blue laser) and an objective lens having an NA (Numerical Aperture) of 0.85 are used in combination. The recording or reproduction operation is performed with a track pitch of 0.32 μm and a linear density of 0.12 μm/bit and in 64 KB (Kilobyte) data blocks, each of which forms a recording or reproduction unit (RUB: Recording Unit Blocks).

In the case of a reproduction-only disc, reproduction-only data is recorded thereon in the form of embossed pits having a depth of approximately λ/4. The track pitch and the linear density are 0.32 μm and 0.12 μm/bit, respectively, similarly to the recordable disc. Further, a data block of 64 KB is handled as a reproduction unit (RUB).

The RUB, which constitutes the recording or reproduction unit, includes 498 frames generated from an ECC (Error Correction Code) block (cluster) of 156 symbols by 496 frames and a link area of one frame added to each of the beginning and the end of the ECC block, for example.

In the case of a recordable disc, a groove is formed thereon in a wobbling fashion, and the wobbling groove forms a recording or reproduction track. The wobbling of the groove contains so-called ADIP (Address in Pregroove) data. That is, an address on the disc can be obtained through the detection of wobbling information of the groove.

In the case of a recordable disc, recording marks formed by the phase-change marks are recorded on the track formed by the wobbling groove. The phase-change marks are recorded with a linear density of 0.12 μm/bit or 0.08 μm/ch bit in accordance with an RLL (1, 7) PP modulation method (RLL: Run Length Limited, PP: Parity preserve/Prohibit rmtr (repeated minimum transition runlength)) or the like. When the channel clock cycle is represented as T, the mark length is represented as 2T to 8T.

In the case of a reproduction-only disc, the groove is not formed thereon, but data modulated similarly in the RLL (1, 7) PP modulation method is recorded thereon as embossed pit rows.

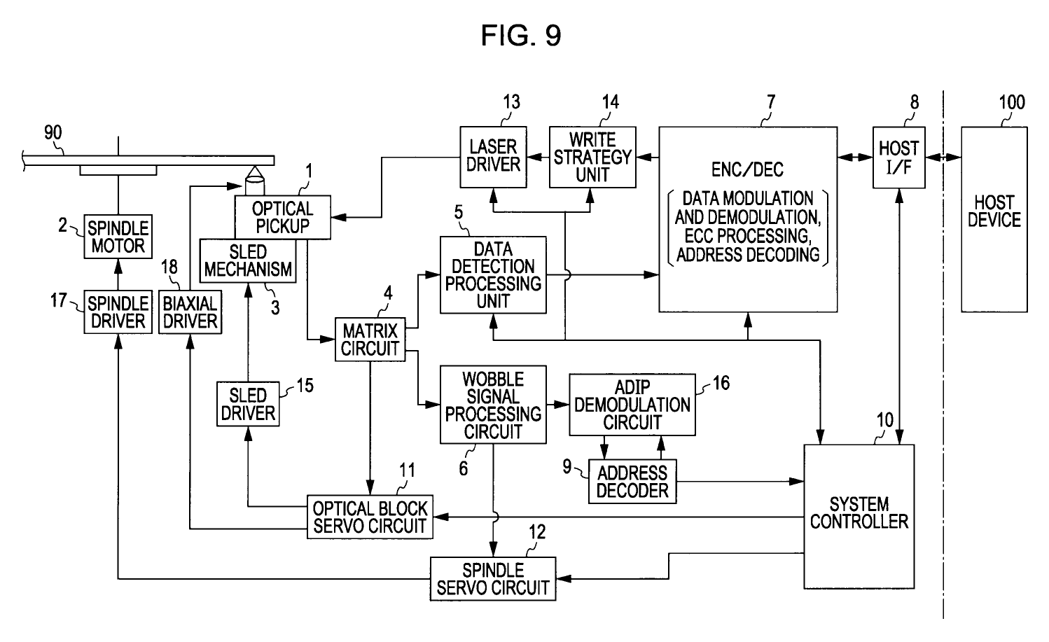

FIG. 9 illustrates a configuration example of a disc drive device capable of performing recording and reproduction operations on the discs as described above. When loaded into the disc drive device, the optical disc 90 of the present example described above is mounted on a not-illustrated turntable. In the recording or reproduction operation, the optical disc 90 is driven to rotate at a constant linear velocity (CLV) by a spindle motor 2.

Further, in the reproduction operation, the mark information recorded in the track on the optical disc 90 is read by an optical pickup (optical head) 1. Further, in the data recording operation on the optical disc 90, user data is recorded, as the phase-change marks or the dye-change marks, in the track on the optical disc 90 by the optical pickup 1.

In the inner circumferential area 91 or the like of the optical disc 90, the physical information of the disc and so forth, for example, are recorded in the form of the embossed pits or the wobbling groove, as reproduction-only management information. The reading of such information is also performed by the optical pickup 1. Further, the optical pickup 1 also reads from the optical disc 90 the ADIP information embedded as the wobbling of the groove track on the optical disc 90.

The optical pickup 1 includes components formed therein, such as a laser diode serving as a laser light source, a photodetector for detecting reflected light, an objective lens serving as an output end of laser light, and an optical system for applying the laser light to a recording surface of the disc via the objective lens and guiding the resultant reflected light to the photodetector. The laser diode outputs so-called blue laser having a wavelength of 405 nm, for example. Further, the optical system has an NA of 0.85.

In the optical pickup 1, the objective lens is held by a biaxial mechanism so as to be movable in the tracking direction and the focusing direction. Further, the entire optical pickup 1 can be moved in the radial direction of the disc by a sled mechanism 3. Further, the laser diode in the optical pickup 1 is driven to emit the laser light by a drive signal (drive current) output from a laser driver 13.

The information of the reflected light from the optical disc 90 is detected by the photodetector, converted into an electrical signal in accordance with the received light amount, and supplied to a matrix circuit 4. The matrix circuit 4 includes a current-to-voltage conversion circuit, a matrix operation and amplification circuit, and so forth for the current output from a plurality of light-receiving elements serving as the photodetector, and generates necessary signals through matrix operation processing.

For example, the matrix circuit 4 generates a reproduced information signal (RF (Radio Frequency) signal) corresponding to reproduced data, a focus error signal and a tracking error signal for servo control, and so forth. Further, the matrix circuit 4 generates a push-pull signal as a signal relating to the wobbling of the groove, i.e., a signal for detecting the wobbling.

The reproduced information signal, the focus error signal and the tracking error signal, and the push-pull signal, which are output from the matrix circuit 4, are supplied to a data detection processing unit 5, an optical block servo circuit 11, and a wobble signal processing circuit 6, respectively.

The data detection processing unit 5 performs binarization processing of the reproduced information signal. For example, the data detection processing unit 5 performs A/D (Analog-to-Digital) conversion processing of the RF signal, reproduction clock generation processing by a PLL (Phase-Locked Loop), PR (Partial Response) equalization processing, Viterbi decoding (maximum likelihood decoding), and so forth. Further, the data detection processing unit 5 performs partial response maximum likelihood decoding processing (PRML (Partial Response Maximum Likelihood) detection method), to thereby obtain a binary data string. Then, the data detection processing unit 5 supplies an encoding and decoding unit 7 at a subsequent stage with the binary data string as the information read from the optical disc 90.

The encoding and decoding unit 7 performs the demodulation processing of the reproduced data in the reproduction operation, and the modulation processing of the recording data in the recording operation. That is, in the reproduction operation, the encoding and decoding unit 7 performs data demodulation, deinterleaving, ECC decoding, address decoding, and so forth. Further, in the recording operation, the encoding and decoding unit 7 performs ECC encoding, interleaving, data modulation, and so forth.

In the reproduction operation, the binary data string decoded by the above-described data detection processing unit 5 is supplied to the encoding and decoding unit 7. The encoding and decoding unit 7 performs the demodulation processing of the above-described binary data string to obtain the reproduced data from the optical disc 90. That is, the encoding and decoding unit 7 performs, on the data subjected to the RLL (1, 7) PP modulation and recorded on the optical disc 90, the demodulation processing and the ECC decoding processing for error correction, to thereby obtain the reproduced data from the optical disc 90.

The data decoded into the reproduced data by the encoding and decoding unit 7 is transferred to a host interface 8, and is transferred to a host device 100 on the basis of an instruction from a system controller 10. The host device 100 includes, for example, a computer device, an AV (Audio-Visual) system equipment, and so forth.

In the recording or reproduction operation on the optical disc 90, the ADIP information is processed. That is, the push-pull signal output from the matrix circuit 4 as the signal relating to the wobbling of the groove is converted into digitized wobble data by the wobble signal processing circuit 6. Further, a clock in synchronization with the push-pull signal is generated by the PLL processing.

The wobble data is subjected to MSK (Minimum Shift Keying) demodulation and STW (Saw Tooth Wobble) demodulation by an ADIP demodulation circuit 16 to be demodulated into a data stream forming an ADIP address, and is supplied to an address decoder 9. The address decoder 9 decodes the supplied data to obtain an address value, and supplies the address value to the system controller 10.

In the recording operation, the recording data is transferred from the host device 100, and is supplied to the encoding and decoding unit 7 via the host interface 8. In this case, the encoding and decoding unit 7 performs, as the encoding processing of the recording data, the addition of an error correction code (ECC encoding), the interleaving, the addition of a sub-code, and so forth. Further, the encoding and decoding unit 7 performs modulation according to the RLL (1, 7) PP method on the data subjected to the above-described processes.

A write strategy unit 14 performs, on the recording data processed by the encoding and decoding unit 7, recording compensation processing, such as the fine adjustment of the optimal recording power in accordance with the characteristics of the recording layers, the spot shape of the laser light, the recording linear velocity, and so forth, and the adjustment of the laser drive pulse waveform. The resultant recording data is supplied to the laser driver 13 as laser drive pulses.

Then, the laser driver 13 supplies the laser drive pulses subjected to the recording compensation processing to the laser diode in the optical pickup 1, to thereby drive the laser diode to emit the laser light. As a result, marks according to the recording data are formed on the optical disc 90. The laser driver 13 includes a so-called APC (Auto Power Control) circuit to control the laser output to be constant, unaffected by the temperature and so forth, while monitoring the laser output power on the basis of the output from a laser power monitoring detector provided in the optical pickup 1. The laser driver 13 receives from the system controller 10 the laser output target value for the recording or reproduction operation, and controls the laser output level to be the target value in the recording or reproduction operation. The optimal laser power for the recording operation is set by laser power adjustment processing described later.

On the basis of the focus error signal and the tracking error signal received from the matrix circuit 4, the optical block servo circuit 11 generates a variety of servo drive signals for focusing, tracking, and sledding operations, to thereby execute servo operations. That is, the optical block servo circuit 11 generates a focus drive signal and a tracking drive signal in accordance with the focus error signal and the tracking error signal, respectively, to thereby cause a biaxial driver 18 to drive a focusing coil and a tracking coil of the biaxial mechanism in the optical pickup 1. Accordingly, the optical pickup 1, the matrix circuit 4, the optical block servo circuit 11, the biaxial driver 18, the biaxial mechanism form a tracking servo loop and a focusing servo loop.

Further, in accordance with a track jump command from the system controller 10, the optical block servo circuit 11 turns off the tracking servo loop, and outputs a jump drive signal to execute a track jump operation.

Further, the optical block servo circuit 11 generates a sled drive signal on the basis of, for example, a sled error signal obtained as a low-frequency component of the tracking error signal and access execution control performed by the system controller 10, and causes a sled driver 15 to drive the sled mechanism 3. Although not illustrated, the sled mechanism 3 includes a mechanism formed by a main shaft for holding the optical pickup 1, a sled motor, a transmission gear, and so forth. The sled motor is driven in accordance with the sled drive signal. Thereby, necessary sliding movement of the optical pickup 1 is performed.

A spindle servo circuit 12 controls the spindle motor 2 to perform CLV rotation. The spindle servo circuit 12 obtains, as the current rotation velocity information of the spindle motor 2, the clocks generated by the PLL processing performed on the wobble signal. Then, the spindle servo circuit 12 compares the information with predetermined CLV reference velocity information to generate a spindle error signal. In the data reproduction operation, the reproduction clocks generated by the PLL in the data detection processing unit 5 serve as the current rotation velocity information of the spindle motor 2. Therefore, the spindle servo circuit 12 can also generate the spindle error signal by comparing the information with predetermined CLV reference velocity information.

Then, the spindle servo circuit 12 outputs a spindle drive signal generated in accordance with the spindle error signal, to thereby cause a spindle driver 17 to perform the CLV rotation of the spindle motor 2. Further, the spindle servo circuit 12 generates a spindle drive signal in accordance with a spindle kick or brake control signal from the system controller 10, to thereby execute such operations as activation, stopping, acceleration, and deceleration of the spindle motor 2.

The above-described variety of operations of the servo system and the recording and reproduction system are controlled by the system controller 10 formed by a microcomputer. The system controller 10 performs a variety of processing in accordance with commands from the host device 100 supplied via the host interface 8.

For example, upon issuance of a write command by the host device 100, the system controller 10 first moves the optical pickup 1 to the address at which data should be written. Then, the system controller 10 causes the encoding and decoding unit 7 to perform the encoding processing in the above-described manner on the data transferred from the host device 100 (e.g., video data and audio data). Then, in accordance with the data encoded as described above, the laser driver 13 performs the laser light emission driving. Thereby, the recording operation is performed.

Further, for example, upon receipt of a read command supplied by the host device 100 to request the transfer of certain data recorded on the optical disc 90, the system controller 10 first performs seek operation control by setting the specified address as the target. That is, the system controller 10 issues a command to the optical block servo circuit 11 to cause the optical pickup 1 to perform an access operation in which the address specified by a seek command is set as the target.

Thereafter, the system controller 10 performs operation control for transferring the data in the specified data section to the host device 100. That is, the system controller 10 reads the data from the optical disc 90, causes the data detection processing unit 5 and the encoding and decoding unit 7 to perform the reproduction processing, and transfers the requested data.

The description has been made of the example of FIG. 9 as a disc drive device connected to the host device 100. Meanwhile, a disc drive device according to an embodiment of the present invention may not be connected to another device. In such a case, the disc drive device may be provided with an operation unit and a display unit, and may be different from the disc drive device of FIG. 9 in the configuration of the data input and output interface section. That is, the disc drive device may perform the recording or reproduction operation in accordance with the operation performed by a user, and may be provided with a terminal section for inputting and outputting a variety of data. A variety of other examples are conceivable, of course, as the configuration of the disc drive device.

5) Laser Power Adjustment Processing: In the recording operation on the optical disc 90, the present disc drive device performs the adjustment to the optimal recording laser power prior to the actual recording operation. The laser power adjustment is performed on the basis of the trial writing performed in the respective OPC areas of the recording layers in a multilayer disc.

The laser power adjustment processing (optimal recording laser power determination processing) may be performed in each of the recording layers upon loading of the optical disc 90, for example. Alternatively, the adjustment processing may be performed in each of the recording layers immediately before the actual recording operation. Still alternatively, the adjustment processing may be performed only in a recording layer set as the recording target immediately before the actual recording operation.

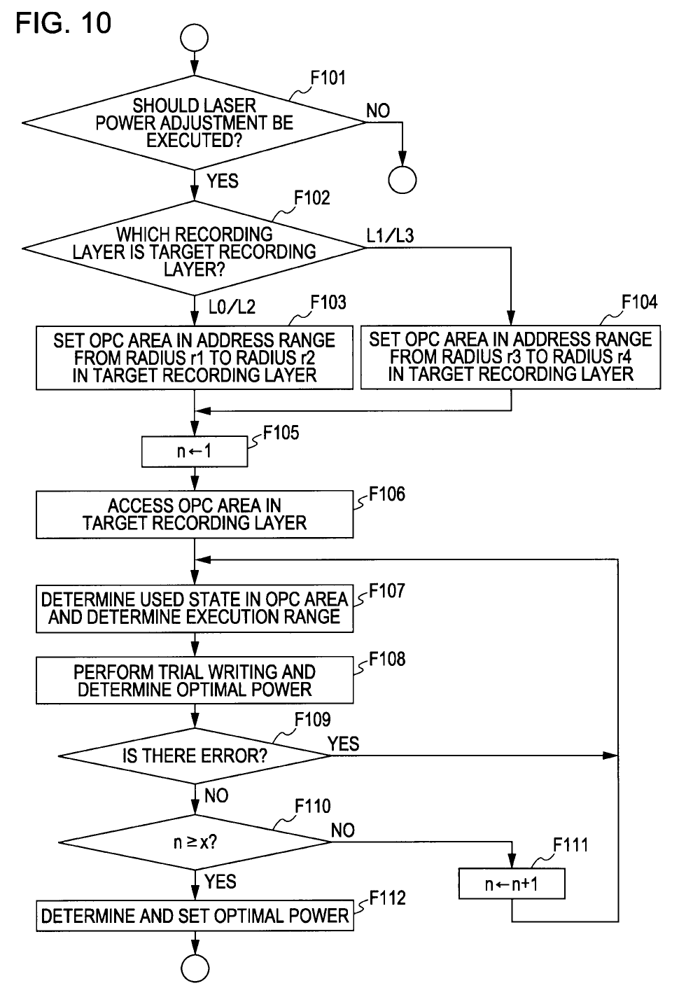

FIG. 10 illustrates an example of the laser power adjustment processing performed by the system controller 10. The optical disc 90 is assumed to be a four-layer disc having the structure illustrated in FIG. 2. Upon arrival of the adjustment execution timing as described above, the system controller 10 proceeds the processing of FIG. 10 from Step F101 to Step F102 to start the laser power adjustment processing.

At Step F102, the system controller 10 selects a process to be performed, on the basis of the recording layer on which the optimal laser power determination is to be performed. If the determination is to be performed on the recording layer L0, the system controller 10 proceeds the processing to Step F103, and recognizes that the OPC area is the range from the radius of r1 to the radius of r2 in the optical disc 90. If the determination is to be performed on the recording layer L1, the system controller 10 proceeds the processing to Step F104, and recognizes that the OPC area is the range from the radius of r3 to the radius of r4 in the optical disc 90. If the determination is to be performed on the recording layer L2, the system controller 10 proceeds the processing to Step F103, and recognizes that the OPC area is the range from the radius of r1 to the radius of r2 in the optical disc 90. If the determination is to be performed on the recording layer L3, the system controller 10 proceeds the processing to Step F104, and recognizes that the OPC area is the range from the radius of r3 to the radius of r4 in the optical disc 90.

After the recognition of the OPC area in the recording layer set as the execution target, the system controller 10 executes the trial writing at Step F105 and the subsequent steps. Firstly, at Step F105, the system controller 10 sets a variable n for controlling the number of trial writings to be one. Then, at Step F106, the system controller 10 causes the optical pickup 1 to access the OPC area in the target recording layer.

At Step F107, the system controller 10 determines the range in the OPC area, in which the trial writing is to be actually performed. For this purpose, the system controller 10 executes the reproduction operation in the OPC area from the beginning of the OPC area. That is, the system controller 10 instructs the laser driver 13 to output the laser with the reproduction power, to thereby cause the optical pickup 1 to output the reproduction laser power and perform the reproduction scanning operation from the beginning of the OPC area. With the reproduction of the OPC area, a used region and an unused region in the OPC area can be distinguished. Then, the system controller 10 determines the trial writing execution range in the unused region.

After the determination of the trial writing execution range, the system controller 10 at Step F108 executes the actual trial writing operation. For example, the system controller 10 instructs the laser driver 13 to change the recording laser power in a phased manner, and causes the optical pickup 1 to perform the data recording (e.g., random data recording) in the trial writing execution range.

Then, upon completion of the trial writing in the trial writing execution range, the system controller 10 executes the reproduction of data in the region subjected to the trial writing. In this process, the quality of the reproduced data is determined on the basis of indicators such as the error rate obtained by the encoding and decoding unit 7 and the SAM (Sequenced Amplitude Margin) jitter value obtained in the Viterbi decoding by the data detection processing unit 5, for example. In the trial writing, the recording laser power is changed in a phased manner. Therefore, which laser power is optimal can be determined on the basis of the determination of the quality of the reproduced data.

If an error occurs in the process of trial writing and reproduction, the processing returns from Step F109 to Step F107 to again determine the trial writing execution range, and the trial writing and the determination of the reproduced data quality are again performed at Step F108.

At Step F110, the system controller 10 determines whether or not the variable n has reached a predetermined trial writing number X. It is considered that the determination accuracy can be improved more by the determination of the optimal laser power based on a plurality of trial writings than by the determination of the optimal laser power based on a single trial writing, for example. Therefore, the processes of Step F107 and the subsequent steps are repeated while the variable n is incremented at Step F111, until the variable n reaches the predetermined trial writing number X.

After the predetermined number of trial writings and optimal laser power determinations, the system controller 10 determines the optimal laser power at Step F112. If the trial writing has been performed a plurality of times, the average value of optimal laser powers determined for the respective trial writings may be calculated, for example, to determine the final optimal laser power.

Then, the system controller 10 sets and stores the determined optimal laser power as the optimal laser power for the present target recording layer. In the actual recording operation on the recording layer, the system controller 10 instructs the laser driver 13 to use the above set optimal laser power.

As described above, in the laser power adjustment processing for determining the optimal laser power on the basis of the trial writing, the disc drive device of the present example recognizes the OPC area in accordance with the recording layer set as the execution target. Thereby, the disc drive device can perform appropriate trial writing in accordance with the OPC area provided in each of the recording layers as illustrated in FIG. 2, for example. Particularly when the optical disc 90 has the OPC area structure as illustrated in FIG. 2 and FIGS. 3A to 3E, the disc drive device can recognize the OPC area on the basis of whether the target recording layer is an even-numbered layer or an odd-numbered layer.

The present application contains subject matter related to that disclosed in Japanese Priority Patent Application JP 2008-168669 filed in the Japan Patent Office on Jun. 27, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A multilayer optical recording medium comprising:
three or more recording layers formed in a thickness direction,
wherein trial writing areas provided in the respective recording layers to adjust the power of recording laser are formed not to overlap at a position in a planar direction in adjacent ones of the recording layers, and
wherein the trial writing areas are formed to have an overlapping portion at a position in the planar direction in one of the recording layers and at least another one of the recording layers not adjacent to the one of the recording layers.

2. The multilayer optical recording medium according to claim 1,
wherein, in even-numbered ones or odd-numbered ones of the recording layers, the trial writing areas are formed to have an overlapping portion at a position in the planar direction.

3. The multilayer optical recording medium according to claim 1,
wherein the trial writing areas are formed to have an overlapping portion at a position in the planar direction in one of the recording layers and another one of the recording layers, between which at least two or more of the other recording layers are interposed.

4. A recording device for a multilayer optical recording medium,
wherein the multilayer optical recording medium includes three or more recording layers formed in a thickness direction,
wherein trial writing areas provided in the respective recording layers to adjust the power of recording laser are formed not to overlap at a position in a planar direction in adjacent ones of the recording layers,
wherein the trial writing areas are formed to have an overlapping portion at a position in the planar direction in one of the recording layers and at least another one of the recording layers not adjacent to the one of the recording layers, and
wherein the recording device comprises:
an optical head unit configured to apply the recording laser to the multilayer optical recording medium to write information thereon;
a laser driving unit configured to drive the optical head unit to output the recording laser; and
a control unit configured to, in the execution of the laser power adjustment of the recording laser output from the optical head unit, identify the position in the planar direction of the trial writing areas in accordance with the recording layer set as an adjustment target, determine a trial writing execution range within the identified position in the planar direction, and control the laser driving unit and the optical head unit to execute trial writing in the trial writing execution range.

5. A recording laser power adjustment method of a recording device for a multilayer optical recording medium,
wherein the multilayer optical recording medium includes three or more recording layers formed in a thickness direction,
wherein trial writing areas provided in the respective recording layers to adjust the power of recording laser are formed not to overlap at a position in a planar direction in adjacent ones of the recording layers,
wherein the trial writing areas are formed to have an overlapping portion at a position in the planar direction in one of the recording layers and at least another one of the recording layers not adjacent to the one of the recording layers, and
wherein the recording laser power adjustment method comprises the steps of:
identifying the position in the planar direction of the trial writing areas in accordance with the recording layer set as an adjustment target;
determining a trial writing execution range within the identified position in the planar direction;
executing trial writing in the determined trial writing execution range; and
reproducing data in a region subjected to the trial writing, determining an optimal laser power, and setting the determined optimal laser power as the recording laser power.
